(19) United States
(12) Patent Application Publication
(10) Pub. No.: US 2026/0080192 A1
(43) Pub. Date: Mar. 19, 2026

(54) INFORMATION PROCESSING METHOD, PROGRAM, TERMINAL APPARATUS, INFORMATION PROCESSING METHOD, AND INFORMATION PROCESSING SYSTEM

(71) Applicant: POCKETALK CORPORATION, Minato-ku, Tokyo (JP)

(72) Inventor: Hajime KAWATAKE, Minato-ku, Tokyo (JP)

(73) Assignee: POCKETALK CORPORATION, Minato-ku, Tokyo (JP)

(21) Appl. No.: 19/115,782

(22) PCT Filed: Oct. 4, 2022
(86) PCT No.: PCT/JP2022/037142

§ 371 Date: Mar. 27, 2025

(51) Int. Cl. G06F 40/58; G10L 15/26

(52) U.S. Cl. CPC G06F 40/58; G10L 15/26

(57) ABSTRACT

Translation with high accuracy and with a short waiting time is provided. An information processing method by a terminal apparatus 1, the information processing method including: acquiring speech sound in a translation source language; recognizing the speech sound and generating text corresponding to the speech sound; accumulating a first predetermined number of seconds or a first predetermined number of words of the text in a buffer; detecting a split point of the text accumulated in the buffer, so as to detect a first sentence of the text; acquiring text in a translation target language that corresponds to the first sentence; and displaying the text in the translation target language and/or generating and outputting speech sound corresponding to the text in the translation target language.

### TECHNICAL FIELD

The present disclosure relates to an information processing method, a program, a terminal apparatus, an information processing method, and an information processing method.

### BACKGROUND

Conventionally, technology for translating languages by translating results of recognition of character strings every time certain syntactic structures are accumulated using a syntactic analysis method is known (for example, Patent Literature [PTL] 1).

### CITATION LIST

### Patent Literature

PTL 1: JP 2015-201215 A

### SUMMARY

### Technical Problem

In the case of sentence splitting method according to the conventional technology, because sentences to be split are continuously updated in real time, split points also change in real time. It is therefore not easy to determine when to establish the split points.

It would be helpful to provide translation with high accuracy and with a short waiting time.

### Solution to Problem

An information processing method according to an embodiment of the present disclosure is
an information processing method by a terminal apparatus, the information processing method including:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

A program according to an embodiment of the present disclosure configured to cause a computer to execute operations, the operations including:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

A terminal apparatus according to an embodiment of the present disclosure is
a terminal apparatus including a controller, wherein the controller is configured to execute operations including:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

An information processing method according to an embodiment of the present disclosure is
an information processing method by an information processing system including a terminal apparatus and an information processing apparatus communicable with the terminal apparatus, the information processing method including:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

An information processing system according to an embodiment of the present disclosure is
an information processing system including a terminal apparatus and an information processing apparatus communicable with the terminal apparatus, the information processing system being configured to execute operations including:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

### Advantageous Effect

According to an embodiment of the present disclosure, translation with high accuracy and with a short waiting time can be provided.

### BRIEF DESCRIPTION OF THE DRAWINGS

In the accompanying drawings:

FIG. 1 is a schematic diagram illustrating an information processing system;

FIG. 2 is a block diagram illustrating a configuration of a first terminal apparatus;

FIG. 3 is a block diagram illustrating a configuration of a second terminal apparatus;

FIG. 4 is a block diagram illustrating a configuration of an information processing apparatus;

FIG. 5 is a view illustrating dialogue using the first terminal apparatus;

FIG. 6 is a view illustrating text corresponding to speech sound;

FIG. 7 is a view illustrating a display screen for translation;

FIG. 8 is a sequence diagram illustrating operations executed in the information processing system; and

FIG. 9 is a view illustrating a display screen according to another embodiment.

### DETAILED DESCRIPTION

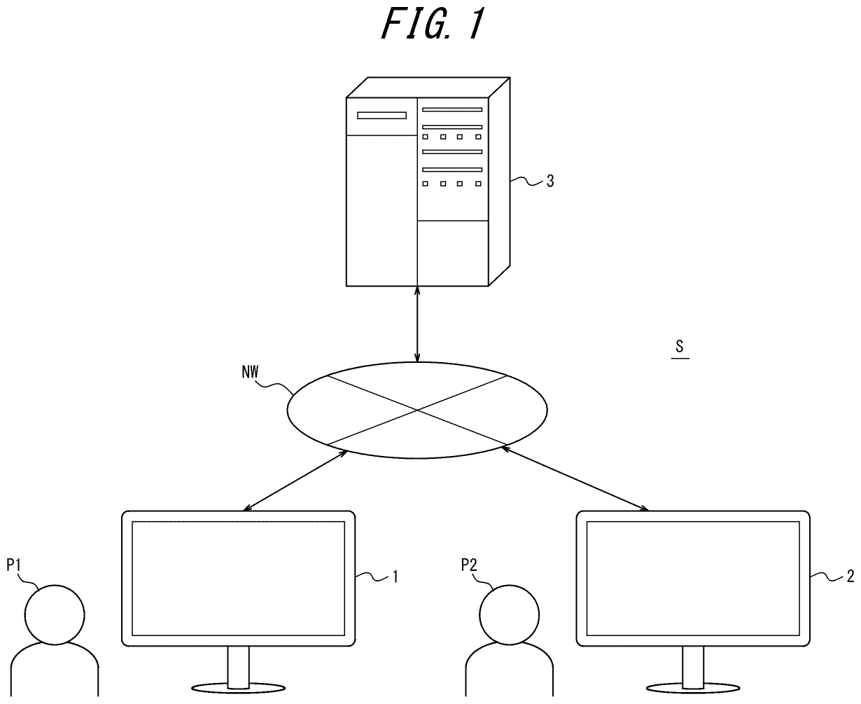

FIG. 1 is a schematic diagram illustrating an information processing system S according to the present embodiment. The information processing system S includes a first terminal apparatus 1, a second terminal apparatus 2, and an information processing apparatus 3 that are communicable with each other via a network NW. The network NW includes, for example, a mobile communication network, a fixed communication network, or the Internet. The first terminal apparatus 1 is used by a first user P1. The second terminal apparatus 2 is used by a second user P2.

In FIG. 1, two terminal apparatuses are illustrated for simplicity of explanation. However, the number of terminal apparatuses is not limited to this.

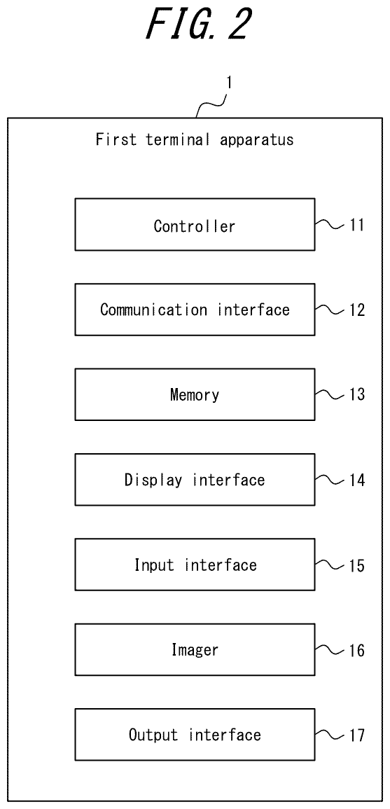

With reference to FIG. 2, an internal configuration of the first terminal apparatus 1 will be described in detail.

The first terminal apparatus 1 may be a general-purpose apparatus, such as a PC, or a dedicated apparatus. The term “PC” is an abbreviation for personal computer. In an alternative example, the first terminal apparatus 1 may be a mobile device, such as a cellular phone, a smartphone, a wearable device, or a tablet.

The first terminal apparatus 1 includes a controller 11, a communication interface 12, a memory 13, a display interface 14, an input interface 15, an imager 16, and an output interface 17. The respective components of the first terminal apparatus 1 are communicably connected to each other via, for example, a dedicated line.

The controller 11 includes, for example, one or more general-purpose processors, such as a Central Processing Unit (CPU) or a Micro Processing Unit (MPU). The controller 11 may include one or more dedicated processors that are dedicated to specific processing. The controller 11 may include one or more dedicated circuits, instead of processors. Examples of dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes one or more communication modules for connection to the network NW that conform to wired or wireless Local Area Network (LAN) standards. The communication interface 12 may include a module conforming to one or more mobile communication standards, including the Long Term Evolution (LTE) standard, the 4^{th} Generation (4G) standard, and the 5^{th} Generation (5G) standard. The communication interface 12 may include one or more communication modules or the like conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), and RFID. The communication interface 12 transmits and receives any information via the network NW.

The memory 13 may be, but is not limited to, a semiconductor memory, a magnetic memory, an optical memory, or a combination of at least two of these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the first terminal apparatus 1. The memory 13 may store a system program, an application program, embedded software, or the like. The memory 13 may be provided outside the first terminal apparatus 1 and accessed by the fist terminal apparatus 1.

The display interface 14 is, for example, a display. The display is, for example, an LCD or an organic EL display. The term “LCD” is an abbreviation for liquid crystal display. The term “EL” is an abbreviation for electro luminescence. The display interface 14 may be connected to the first terminal apparatus 1 as an external output device, instead of being included in the first terminal apparatus 1. As a connection method, any method, such as USB, HDMI® (HDMI is a registered trademark in Japan, other countries, or both), or Bluetooth®, can be used.

Examples of the input interface 15 may include physical keys, capacitive keys, a pointing device, a touchscreen integrally provided in the display, and a microphone. The input interface 15 receives an operation for inputting information to be used for operations of the first terminal apparatus 1. The input interface 15 may be connected to the first terminal apparatus 1 as an external input device, instead of being included in the first terminal apparatus 1. As a connection method, any method, such as USB, HDMI®, or Bluetooth®, can be used. The term “USB” is an abbreviation for universal serial bus. The term “HDMI®” is an abbreviation for high-definition multimedia interface.

The imager 16 includes a camera. The imager 16 can capture images of the surroundings. The imager 16 may record the captured images in the memory 13 or transmit them to the controller 11 for image analysis. The images include still images or moving images.

The output interface 17 includes a speaker that outputs speech sound.

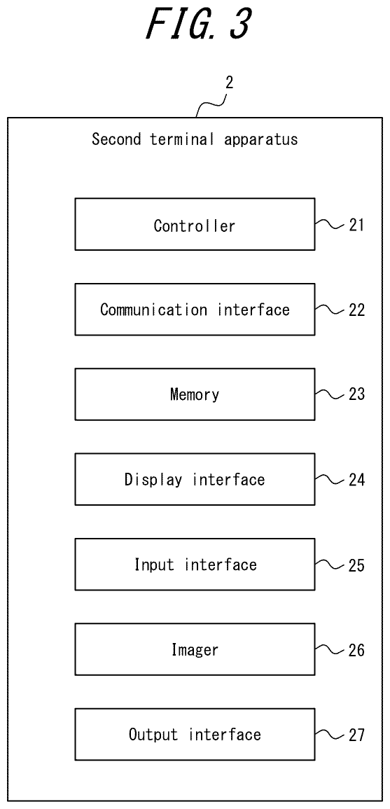

With reference to FIG. 3, an internal configuration of the second terminal apparatus 2 will be described in detail.

The second terminal apparatus 2 includes a controller 21, a communication interface 22, a memory 23, a display interface 24, an input interface 25, an imager 26, and an output interface 27. The description of the hardware configuration of the second terminal apparatus 2 may be identical to the description of the hardware configuration of the first terminal apparatus 1. The description will be omitted here.

The information processing apparatus 3 may be a server that supports provision of services by a service provider. The information processing apparatus 3 may be installed, for example, in a facility dedicated to the service provider or in a shared facility, including a data center.

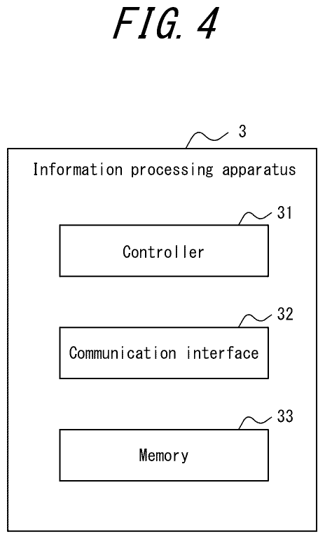

With reference to FIG. 4, an internal configuration of the information processing apparatus 3 will be described in detail.

The information processing apparatus 3 includes a controller 31, a communication interface 32, and a memory 33. The description of the hardware configuration of the controller 31, the communication interface 32, and the memory 33 of the information processing apparatus 3 may be identical to the description of the hardware configuration of the controller 11, the communication interface 12, and the memory 13 of the first terminal apparatus 1. The description will be omitted here.

In the following, an information processing method executed in the information processing system S will be described in detail. In an example here, the first user P1 and the second user P2 who are located in different places conduct a remote dialogue (e.g., remote conference) in different languages using the information processing system S. Here, the first user P1 speaks Japanese, and the second user P2 speaks English. The number of people conducting the dialogue can be any number more than one.

Each of the first terminal apparatus 1 and the second terminal apparatus 2 captures images of the user using the terminal apparatus with the imager 16 or the imager 26 and sequentially transmits the captured images to the other terminal apparatus.

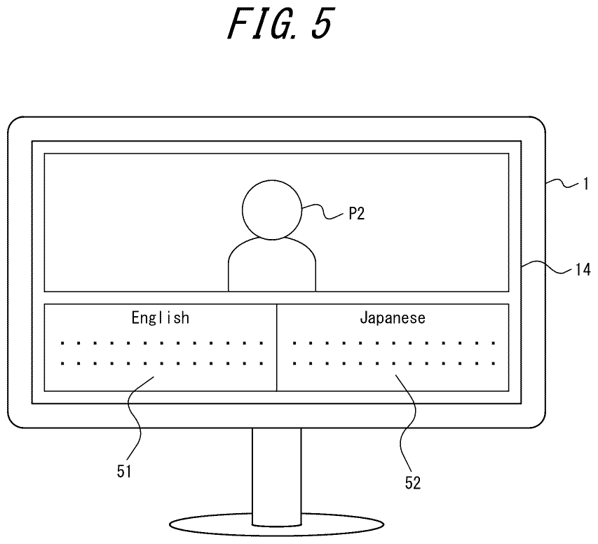

As illustrated in FIG. 5, the display interface 14 of the first terminal apparatus 1 displays a captured image of the second user P2, who is the dialogue partner. The controller 11 of the first terminal apparatus 1 translates the English text 51 spoken by the second user P2 into Japanese text 52 and displays it on the display interface 14 according to a later-described method.

The controller 21 of the second terminal apparatus 2 acquires speech sound in the translation source language spoken by the second user P2 via the microphone of the input interface 25 and transmits it as speech sound data to the first terminal apparatus 1 via the communication interface 22. The translation source language may be any language, and it is English in the example here.

The controller 11 of the first terminal apparatus 1 acquires the speech sound of the second user P2 from the second terminal apparatus 2. In an alternative example, the controller 11 may acquire speech sound of the second user P2 who is located in the vicinity of the first user P1, via the input interface 15. In another alternative example, the controller 11 may acquire speech sound of video being viewed on the first terminal apparatus 1.

The controller 11 may output the acquired speech sound via the output interface 17.

The controller 11 recognizes the acquired speech sound and generates text corresponding to the speech sound as text data. Any text generation method can be used. The controller 11 may acquire the speech sound via the information processing apparatus 3. The text corresponding to the speech sound increases while the second user P2 continues to speak. As a speech sound recognition engine, the controller 11 may use Artificial Intelligence (AI) provided by the following website, for example.
https://github.com/alphacep/vosk-api

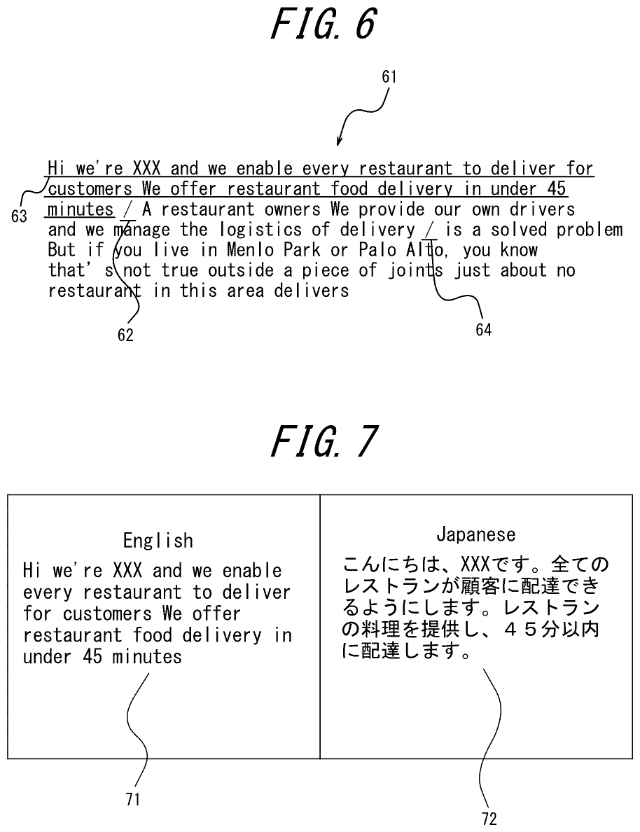

The controller 11 accumulates the first 10 seconds of the generated text in a buffer of the memory 13. FIG. 6 illustrates text 61 for the first 10 seconds. It can be set freely how many first seconds are accumulated in the memory 13. In an alternative example, the controller 11 may accumulate the first predetermined number of words (e.g., 100 words) in the buffer of the memory 13.

When detecting that the first 10 seconds have been accumulated, the controller 11 evaluates (detects) a split point 62 of the accumulated text. The division point may be a point for dividing one sentence from the next sentence. Any method of evaluating split points can be used. In an alternative example, in a case in which a split point cannot be detected, the controller 11 may continue to detect a split point by increasing text in the buffer until the split point can be detected. As a sentence splitting engine, the controller 11 may use AI provided by the following website, for example.
https://bminixhofer.github.io/nnsplit/

When detecting text 63 of the first sentence, the controller 11 transmits the text 63 to the information processing apparatus 3. The information processing apparatus 3 translates the text 63 of the first sentence into the translation target language. The translation target language may be any language, and it is Japanese in the example here. The controller 31 of the information processing apparatus 3 transmits the Japanese text to the first terminal apparatus 1. In an alternative example, the first terminal apparatus 1, instead of the information processing apparatus 3, may perform the translation. In another alternative example, when detecting a silent portion of a predetermined number of seconds (e.g., 0.3 seconds) or longer in the speech sound in the translation source language while accumulating the first predetermined number of seconds or the first predetermined number of words of the text in the buffer, the information processing apparatus 3 or the first terminal apparatus 1 may translate the entire text in the buffer. As a translation engine, the controller 31 of the information processing apparatus 3 may use AI provided by the following website, for example.
https://cloud.google.com/translate?hl=ja

When acquiring the text in the translation target language that corresponds to the first sentence from the information processing apparatus 3, the controller 11 generates speech sound corresponding to the text by speech sound synthesis. As a speech sound synthesis method, the controller 11 may use AI provided by the following website, for example.
https://www.global.toshiba/jp/products-solutions/ai-iot/recaius/lineup/tospeak.html?utm_source=www&utm_medium=web&utm_campaign=since2022tdsl

The controller 11 outputs the generated speech sound from the speaker of the output interface 17. As illustrated in FIG. 7, the controller 11 may display English text 71, which is the first sentence of the text in the translation source language, and the corresponding Japanese text 72 in the translation target language, in a pair on the display interface 14. The controller 11 associates the English text 71 and the Japanese text 72 and stores them in the memory 13. The stored data can later be copied or downloaded. The controller 11 displays the text 72 in the translation target language and/or outputs speech sound corresponding to the text 72 in the translation target language. In an additional example, when detecting that the output of the speech sound corresponding to the text in the translation target language is delayed for a predetermined time or longer relative to the output (playback) of the speech sound in the translation source language, the controller 11 may accelerate the playback speed of the speech sound corresponding to the text in the translation target language.

The controller 11 replenishes the buffer of the memory 13 with text for the same number of seconds or words as the number of seconds or words of the first sentence. For example, in a case in which the number of seconds of the first sentence of the output text is 2 seconds, the remaining text in the buffer is for 8 seconds. The controller 11 accumulates the first 2 seconds of the subsequent text following the text 61 in the memory 13. Accordingly, the total text in the buffer is for 10 seconds, consisting of that for 8 seconds and that for 2 seconds.

When detecting that the text for 10 seconds has been accumulated, the controller 11 evaluates a split point of the accumulated text. In an example, the next split point 64 is illustrated in FIG. 6. Thus, the next text to be translated is “A restaurant owners We provide our own drivers and we manage the logistics of delivery.” The method of evaluating the split point is as described above. Subsequent processing (i.e., translation, speech sound output, text display, replenishment, or the like.) is also as described above, and a description thereof will be omitted here.

The Japanese text 72 displayed on the first terminal apparatus 1 is updated while the second user P2 continues to speak.

In an additional example, when detecting that an earphone with a microphone using short-range wireless communication (e.g., Bluetooth) is connected to the first terminal apparatus 1, the controller 11 detects a list of one or more dialogue groups for which the dialogue is to be translated, within a predetermined range (e.g., within a predetermined distance) from the first terminal apparatus 1, and displays the list on the display interface 14. When receiving a selection from the first user P1 for one of the dialogue groups in the list, the controller 11 may acquire speech sound spoken in the selected dialogue group and translates the words into text in a designated language. The designated language is designated by the first user P1. The controller 11 generates speech sound corresponding to the text in the designated language and outputs it via the output interface 17.

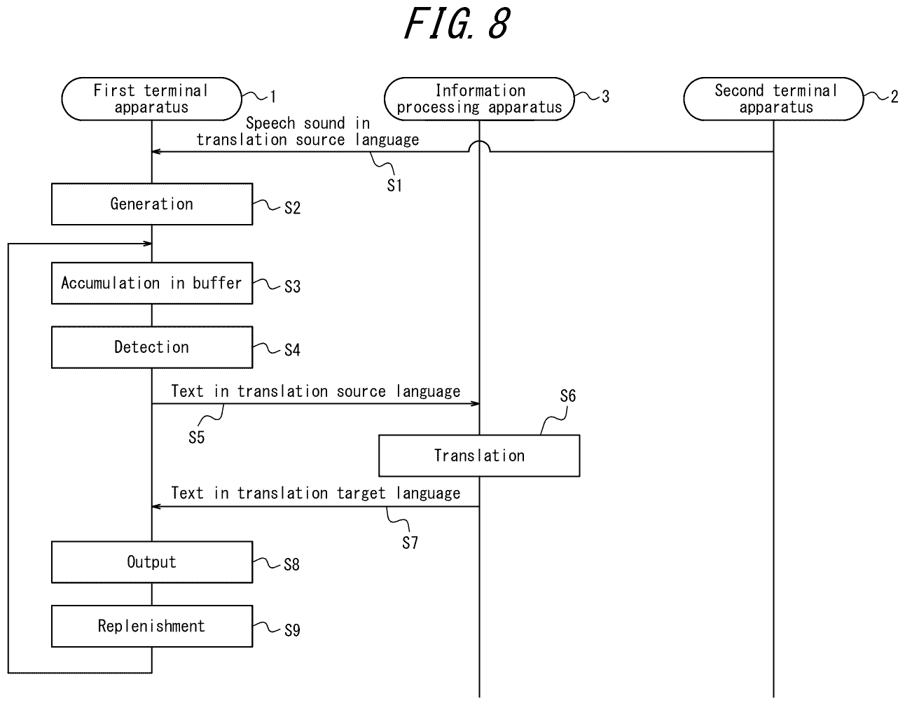

With reference to FIG. 8, the information processing method executed by the information processing system S at any point in time will be described.

In Step S1, the second terminal apparatus 2 transmits speech sound in a translation source language spoken by the second user P2 to the first terminal apparatus 1.

In Step S2, the controller 11 of the first terminal apparatus 1 recognizes the speech sound and generates text corresponding to the speech sound. In Step S3, the controller 11 accumulates the first 10 seconds of the generated text in the buffer of the memory 13. In Step S4, the controller 11 evaluates a split point of the accumulated text and detects the first sentence.

In Step S5, the controller 11 transmits the text in the translation source language to the information processing apparatus 3. The controller 31 of the information processing apparatus 3 translates the text in the translation source language into text in a designated translation target language. The controller 31 of the information processing apparatus 3 transmits the text in the translation target language to the first terminal apparatus 1.

In Step S8, the controller 11 outputs speech sound corresponding to the text acquired from the information processing apparatus 3. In Step S9, the controller 31 replenishes the buffer of the memory 13 with text for the same number of seconds as the number of seconds of the first sentence detected in Step S4.

The controller 11 executes Step S3 and onward again.

### Another Embodiment

In the above embodiment, the speech of the second user P2 is translated into Japanese and output from the first terminal apparatus 1. However, processing executed by the controller 11 of the first terminal apparatus 1 can also be executed by the controller 21 of the second terminal apparatus 2. That is, speech of the first user P1 can be translated into English and output from the second terminal apparatus 2. This configuration allows the first user P1 and the second user P2, who speak different languages, to conduct a dialogue.

In the above embodiment, the processing from Step S2 to Step S4 and Step S9 in FIG. 8 is executed in the first terminal apparatus 1. In an alternative example, the processing from Step S2 to Step S4 and Step S9 may be executed by the information processing apparatus 3. It is possible to freely change which apparatus is used for which processing, in accordance with cost, language, platform, or the like.

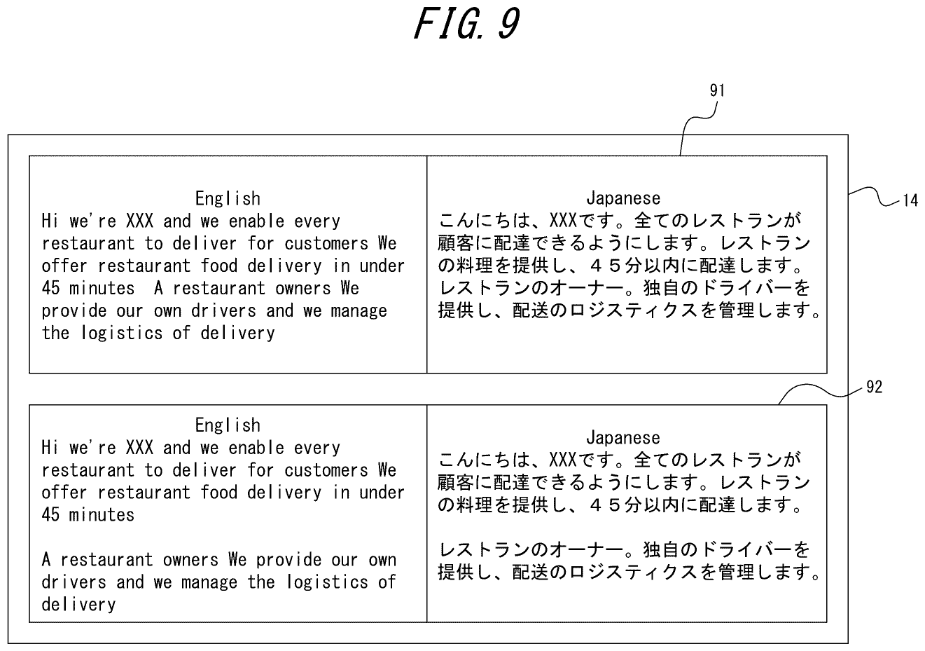

In the above embodiment, as illustrated in FIG. 5, the display interface 14 displays the English text 51 and the corresponding Japanese text 52. In an additional example, as illustrated in FIG. 9, the controller 11 may display on the display interface 14 a parallel translation 91 generated according to a conventional method, in addition to the parallel translation 92 generated according to the above embodiment. The conventional method is a method in which a conventional speech sound recognition engine recognizes speech sound of the second user P2, detects the end of a sentence in the recognized text, and translates the recognized text.

### Advantageous Effects

As described above, according to the present embodiment, the controller 11 of the first terminal apparatus 1 executes operations including: acquiring speech sound in a translation source language; recognizing the speech sound and generating text corresponding to the speech sound; accumulating a first predetermined number of seconds or a first predetermined number of words of the text in a buffer; detecting a split point of the text accumulated in the buffer, so as to detect a first sentence of the text; acquiring text in a translation target language that corresponds to the first sentence; and displaying the text in the translation target language and/or generating and outputting speech sound corresponding to the text in the translation target language. This configuration allows the controller 11 to execute accurate translation with a high probability of being valid as a sentence. Furthermore, the controller 11 can reduce a waiting time or an interval before the speech sound in the translation source language is translated than before, thereby increasing the possibility of use for simultaneous interpretation or the like.

Moreover, according to the present embodiment, the operations of the controller 11 also include: replenishing the buffer with text for the same number of seconds or words as the number of seconds or words of the detected first sentence; and evaluating a split point of text accumulated in the buffer after replenishment, so as to detect a first sentence of the text. This configuration allows the first terminal apparatus 1 to sustain accurate translations.

Moreover, according to the present embodiment, the operations of the controller 11 also include, in a case in which a split point cannot be detected, increasing text in the buffer until the split point can be detected. This configuration allows the first terminal apparatus 1 to improve the feasibility of accurate translation.

Moreover, according to the present embodiment, the operations of the controller 11 include, when detecting silence of a predetermined number of seconds or longer in the speech sound in the translation source language while accumulating the first predetermined number of seconds or the first predetermined number of words of the text in the buffer, acquiring text in the translation target language that corresponds to entire text in the buffer. This configuration allows the first terminal apparatus 1 to improve the feasibility of accurate translation.

Moreover, according to the present embodiment, the operations of the controller 11 include displaying the text of the first sentence in the text in the translation source language and the text in the translation target language that corresponds to the first sentence in a pair. This configuration allows the first terminal apparatus 1 to notify a user of a concrete translation status.

Moreover, according to the present embodiment, the operations of the controller 11 include, when detecting that output of the speech sound corresponding to the text in the translation target language is delayed for a predetermined time or longer relative to output of the speech sound in the translation source language, accelerating a playback speed of the speech sound corresponding to the text in the translation target language. This configuration allows the first terminal apparatus 1 to prevent a long waiting time or a long interval before the speech sound of the translation source language is translated.

Moreover, according to the present embodiment, the operations of the controller 11 include: when detecting that an earphone with a microphone using short-range wireless communication is connected to the first terminal apparatus 1, displaying a list of one or more dialogue groups for which dialogue is to be translated, within a predetermined range from the first terminal apparatus 1; when receiving a selection for one of the dialogue groups in the list, acquiring speech sound spoken in the selected dialogue group and translating the speech sound into text in a designated language; and generating and outputting speech sound corresponding to the text in the designated language. This configuration allows the first terminal apparatus 1 to let a user participate in a dialogue of another group hands-free, without being aware of language barriers.

While the present disclosure has been described with reference to the drawings and examples, it is to be noted that various modifications and revisions may be implemented by those skilled in the art based on the present disclosure. Other changes may be made without departing from the gist of the present disclosure. For example, functions or the like included in each means or each step can be rearranged without logical inconsistency, and a plurality of means or steps can be combined together or divided.

For example, in the above embodiment, a program that executes all or some of the functions or processing of the first terminal apparatus 1, the second terminal apparatus 2, or the information processing apparatus 3 may be recorded on a computer-readable recording medium. The computer-readable recording medium includes a non-transitory computer-readable medium and may be, for example, a magnetic recording apparatus, an optical disc, a magneto-optical recording medium, or a semiconductor memory. The program may be distributed, for example, by selling, transferring, or renting a portable recording medium, such as a Digital Versatile Disc (DVD) or a Compact Disc Read Only Memory (CD-ROM), on which the program is recorded. The program may also be distributed by storing the program in a storage of any server and transmitting the program from the server to another computer. The program may be provided as a program product. The present disclosure may also be implemented as a program that can be executed by a processor.

The computer temporarily stores, in the main memory, the program recorded on a portable recording medium or transferred from a server, for example. The computer uses a processor to read the program stored in the main memory and executes processing with the processor in accordance with the read program. The computer may read the program directly from the portable recording medium and execute processing in accordance with the program. Each time a program is transferred from a server to the computer, the computer may sequentially execute processing in accordance with the received program. Processing may be executed by a so-called ASP-type service that implements functions only by execution instructions and result acquisitions, without transferring the program from a server to the computer. The term “ASP” is an abbreviation for application service provider. Examples of the program include information that is provided for processing by an electronic computer and that is equivalent to the program. For example, data that is not a direct command to the computer but has the properties of specifying processing of the computer is information “equivalent to the program.”

### REFERENCE SIGN LIST

S Information processing system

1. An information processing method by a terminal apparatus, the information processing method comprising:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

2. The information processing method according to claim 1, the information processing method comprising:
replenishing the buffer with text for a same number of seconds or words as a number of seconds or words of the detected first sentence; and
evaluating a split point of text accumulated in the buffer after replenishment, so as to detect a first sentence of the text.

3. The information processing method according to claim 1, the information processing method comprising
in a case in which a split point cannot be detected, increasing text in the buffer until the split point can be detected.

4. The information processing method according to claim 1, the information processing method comprising
when detecting silence of a predetermined number of seconds or longer in the speech sound in the translation source language while accumulating the first predetermined number of seconds or the first predetermined number of words of the text in the buffer, acquiring text in the translation target language that corresponds to entire text in the buffer.

5. The information processing method according to claim 1, the information processing method comprising
displaying the text of the first sentence in the text in the translation source language and the text in the translation target language that corresponds to the first sentence in a pair.

6. The information processing method according to claim 1, the information processing method comprising
when detecting that output of the speech sound corresponding to the text in the translation target language is delayed for a predetermined time or longer relative to output of the speech sound in the translation source language, accelerating a playback speed of the speech sound corresponding to the text in the translation target language.

7. The information processing method according to claim 1, the information processing method comprising:
when detecting that an earphone with a microphone using short-range wireless communication is connected to the terminal apparatus, displaying a list of one or more dialogue groups for which dialogue is to be translated, within a predetermined range from the terminal apparatus;
when receiving a selection for one of the dialogue groups in the list, acquiring speech sound spoken in the selected dialogue group and translating the speech sound into text in a designated language; and
generating and outputting speech sound corresponding to the text in the designated language.

8. A program configured to cause a computer to execute operations, the operations comprising:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

9. A terminal apparatus including a controller, wherein the controller is configured to execute operations comprising:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

10. An information processing method by an information processing system including a terminal apparatus and an information processing apparatus communicable with the terminal apparatus, the information processing method comprising:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.

11. An information processing system including a terminal apparatus and an information processing apparatus communicable with the terminal apparatus, the information processing system being configured to execute operations comprising:
acquiring speech sound in a translation source language;
recognizing the speech sound and generating text corresponding to the speech sound;
accumulating a first predetermined number of seconds or a first predetermined number of words of the text in a buffer;
detecting a split point of the text accumulated in the buffer, so as to detect a first sentence of the text;
acquiring text in a translation target language that corresponds to the first sentence; and
displaying the text in the translation target language and/or generating and outputting speech sound corresponding to the text in the translation target language.
